(19) United States
(12) Patent Application Publication
(10) Pub. No.: US 2006/0150213 A1
(43) Pub. Date: Jul. 6, 2006

(54) Executing module and method thereof for playing multimedia in a wireless communication apparatus

(76) Inventors: Zechary Chang, Taipei (TW); Ken Kung, Beijing (CN); Bing Bian, Beijing (CN)

Correspondence Address: HDSL, 4331 STEVENS BATTLE LANE, FAIRFAX, VA, 22033, US

(21) Appl. No.: 11/014,588

(22) Filed: Dec. 16, 2004

(51) Int. Cl. H04N 5/445

(52) U.S. Cl. 725/37

(57) ABSTRACT

An executing module and method thereof for playing multimedia in a wireless communication apparatus are provided, so that the user can play various multimedia operations in the wireless communication apparatus. Firstly, obtain an animation data. Next, retrieve information data according to one of the animation messages in the animation data. Next, execute the information data. Then, such steps are repeated until all the animation messages in the animation data are executed.

### BACKGROUND OF THE INVENTION

1. Field of the Invention

The present invention relates to an executing module and method thereof for playing multimedia in a wireless communication apparatus, and more specifically in one embodiment, to enable the wireless communication, such as a cell phone or personal data assistant (PDA), to play multimedia, so that users execute various types of multimedia operations, such as languages learning or to use animations, by the wireless communication.

2. Description of the Related Art

The development of global communications and transportation has resulted in a more frequent international communication. Therefore, language technique has become more and more important.

In the past, we learned languages through school education or private tutoring classes. One teacher was responsible to instruct or teach many students in a class. Therefore, the interaction between individual student and the teacher was insufficient to facilitate efficient learning. In addition, students had to attend the class in a specific location, which wastes a lot of time in traffic. The class can sometimes be so very costly, that many people can not afford it.

The modern technologies allow learning taking place privately with a more affordable cost. That is, many of the language courses can be written as a program and played in a personal computer. Therefore, the students do not need to go to a specific location and spend a lot of money for each single class. More importantly, the classes can be repeated as many times as the user or learner wants.

Currently, many portable language learning devices have been developed. The portability further enhances the convenience of the users. However, the learning materials are limited to whatever pre-stored in the machine. Or additional storage medium such as a flash memory or disks are required and inserted to the machine to provide more pre-stored learning programs.

The wireless technology allows users to communicate with each other more conveniently. By installing the language learning function into wireless devices, such as cell phones or personal data assistances, the user is not only allowed to learn from a pre-stored program, but also allowed to learn from another wireless device through air. The interaction often provides a better learning effect. If the interactive learning program can be played as an animation, the learning efficiency will be further improved. However, how to incorporate multimedia function into a wireless communication apparatus is still a challenge thus far.

### BRIEF SUMMARY OF THE INVENTION

Accordingly, the present invention is directed to an executing module and method thereof for playing multimedia in a wireless communication device, thereby enable the wireless communication to play multimedia.

An object of the present invention is to provide an executing module and method thereof for playing multimedia in a wireless communication device, so that the user can use the wireless communication device to play programs in the form of animations at any location.

An object of the present invention is to provide an executing module and method thereof for playing multimedia in a wireless communication device, that can download multimedia information through a network.

To achieve these and other advantages and in accordance with the purpose of the present invention, as embodied and broadly described, a executing method for playing multimedia in a wireless communication device includes the steps of obtaining animation data, retrieving information data according to one animation message of the animation data, executing retrieved information data, and repeating these two steps until all the animation messages of the animation data are executed.

The executing method for playing multimedia in a wireless communication device further includes a step of analyzing the animation message.

Moreover, an application program, such as a Java application program, is used to perform each step of the executing method for playing multimedia in a wireless communication device.

In another aspect, an executing module for playing multimedia in a wireless communication apparatus includes a storage module for storing animation data and information data wherein each animation data includes animation messages, a retrieving module connected to the storing module for retrieving one of the animation messages in animation data, a comparison module connected to the retrieving module for analyzing the animation message in retrieved animation message and obtaining the information data according to analyzed animation message, and an executing module connected to the comparison module for executing the information data to play an animation.

Moreover, the storage module of executing module for playing multimedia is operative to store the animation data and the information data, such as one picture, one text and one sound, all which are downloaded from a network by the wireless communication apparatus.

### BRIEF DESCRIPTION OF THE DRAWINGS

The above objects and advantages of the present invention will be become more apparent by describing in detail exemplary embodiments thereof with reference to the attached drawings, in which:

FIG. 1A is a flowchart showing an executing method for playing multimedia in a wireless communication device according to an embodiment of the present invention;

FIG. 1B is a flowchart showing an executing method for playing multimedia in a wireless communication device according to another embodiment of the present invention;

FIG. 2A illustrates an embodiment of the format of animation data in FIGS. 1A and 1B;

FIG. 2B illustrates an embodiment of the format of a animation message in FIG. 2A;

FIG. 2C illustrates an embodiment of the format of a picture index message in FIG. 2B;

FIG. 2D illustrates an embodiment of the format of a picture address message in FIG. 2B;

FIG. 3A illustrates another embodiment of the format of animation data in FIGS. 1A and 1B;

FIG. 3B illustrates another embodiment of the format of a animation message in FIG. 3A; and

FIG. 4 is a block diagram of an executing module for playing multimedia in a wireless communication device according to another embodiment of the present invention.

### DETAILED DESCRIPTION OF THE INVENTION

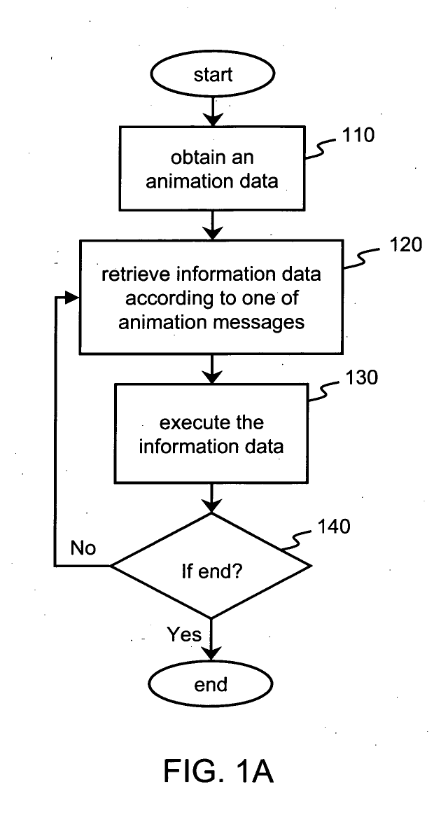

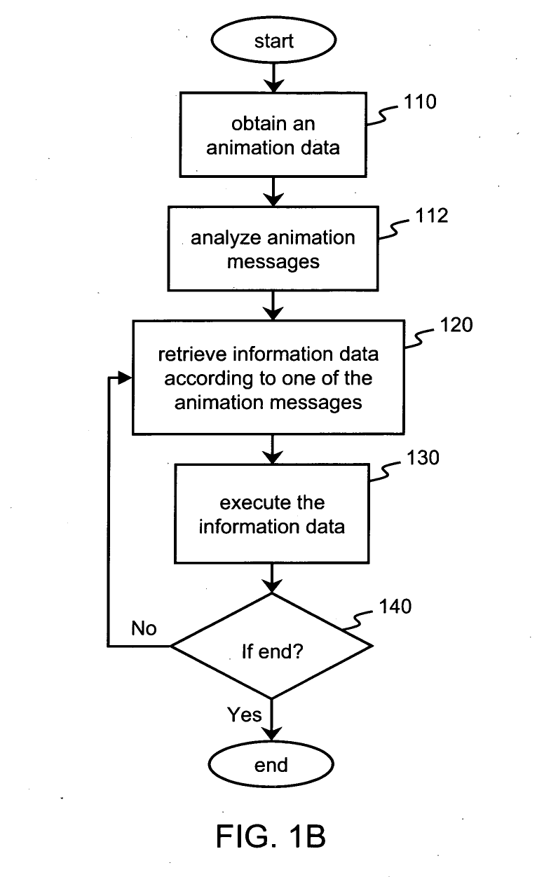

Referring to FIG. 1A, in this case, the executing method for playing multimedia in a wireless communication device includes the steps of obtaining an animation data (step 110), retrieving an information data according to one animation message of the animation data (step 120), executing the information data (step 130), and repeating the steps 110 and 130 until all the animation messages of the animation data are executed (step 140).

As shown in FIG. 1B, the execution method for playing multimedia further comprises the step of analyzing the animation message (step 112).

The information data comprises texts, pictures and sounds.

In this case, the execution method for playing multimedia is performed via an application program such as a Java application program, or another program having similar functions.

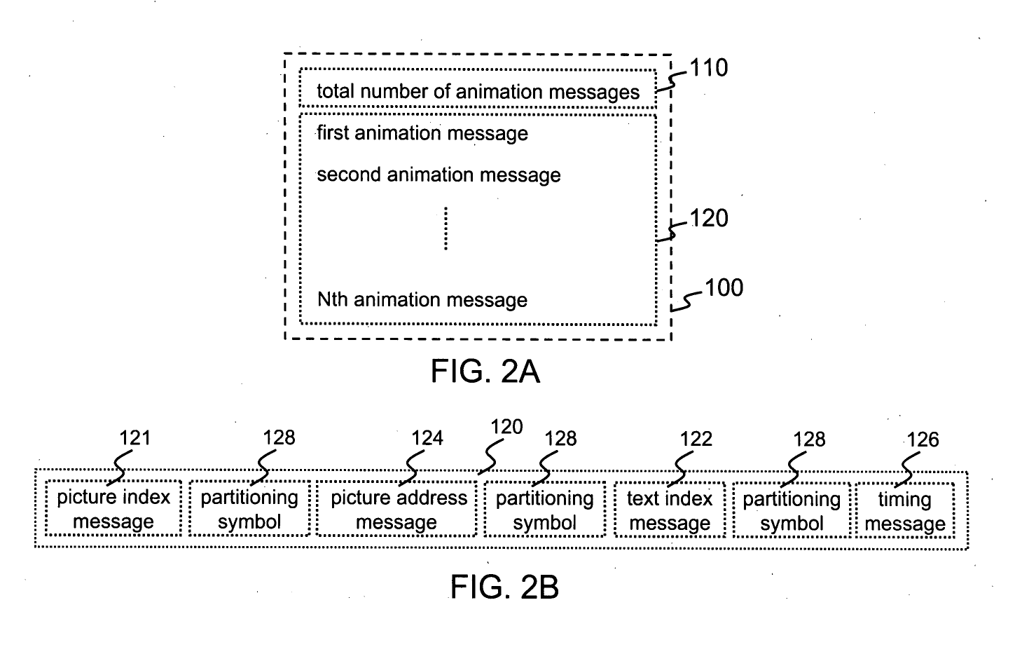

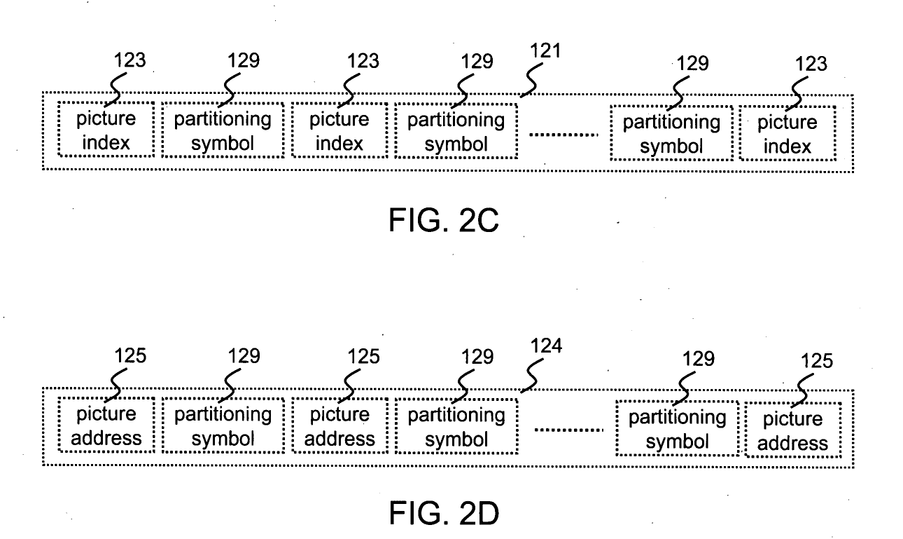

More specifically, while playing multimedia animations, an animation data 100 who's the exemplary format is as shown in FIG. 2A is obtained first. The animation data 100 include a total number of animation messages 110 to indicate the quantity of animation messages 120, and animation messages l20 for retrieving corresponding information data to play animation.

The format of the animation messages 120 is as shown in FIG. 2B. Each animation message 120 includes information data index messages to determine the required information data, information data address messages 124 for locating the information data, timing message 126 for determining display time, and first partitioning symbols 128 for partitioning each message-type. The information data index messages include a picture index message 121 and a text index message 122.

Each information data index message includes at least one information data index separated from another one by a second partitioning symbol 129. As shown in FIG. 2C, the picture index message 121 includes at least one picture index 123 separated from another one by the second partitioning symbols 129.

In addition, the information data address message includes at least one information data address separated from another one by the second partitioning symbols 129. Referring to FIG. 2D, the picture address message 124 has at least one picture address 125 separated from another one by the second partitioning symbols 129 as well.

Each of the information data indices has a corresponding information data address. Similarly each of the picture indices has a corresponding picture address

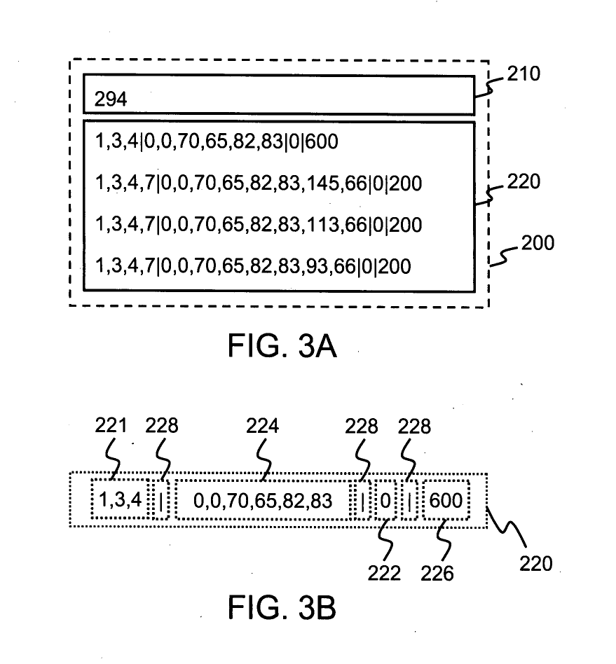

For example, while displaying multimedia animations, an animation data 200 whose format is as shown in FIG. 3A is obtained. The animation data 200 includes a total number of the animation messages 210 and a plurality of animation messages 220. In this case, the total number of the animation messages 210, is “294”. There are four animation messages 220 each being composed of a bit sequence in the animation data 200.

Referring to FIG. 3B, the first animation message includes a picture index message 221, a picture data address message 224, a text index message 222, a timing message 226 and first partitioning symbols 228. The first partitioning symbol 228 is used to partition each type of message. The picture index message 221 is “1, 3, 4”, the picture data address message 224 is “0, 0, 70, 65, 82, 83”, the text index message 222 is “0”, and each first partitioning symbol 228 is “|”. The numbers “1”, “3” and “4” in the picture index message 221 are the picture indices, and the comma symbols “,” are the second partitioning symbols. The “0, 0”, “70, 65” and “82, 83” in the picture data address message 224 are picture addresses, and similarly, these picture addresses are separated from each other by the second partitioning symbol “,”. Each of the picture indices has a corresponding picture address.

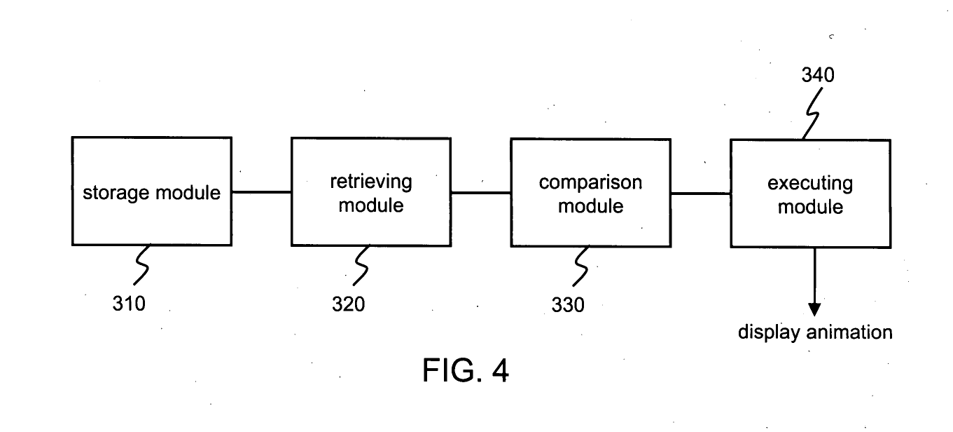

The above method can be performed by an executing module for playing multimedia in a wireless communication device. Referring to FIG. 4, in this case, the executing module for playing multimedia in a wireless communication device includes a storage module 310 for storing animation data and information data, a retrieving module 320 connected to the storing module 310, a comparison module 330 connected to the retrieving module 320, and an executing module 340 connected to the comparison module 330. The animation data include a plurality of animation messages. The retrieving module 320 is operative to retrieve the animation data from the storing module 310. The comparison module 330 analyzes the animation messages in the animation data obtained by the retrieving module 320 to obtain information data according to the animation messages. The executing module 340 executes the obtained information data thereby generates an animation.

The information data include texts, pictures, sounds, and so on. The wireless communication apparatus download animation data, information data or both of them from a network and stores the downloaded data in the storage module. Therefore, the wireless communication apparatus is able to display multimedia animation on a display screen by executing the information messages.

The executing module and method thereof for playing multimedia in a wireless communication apparatus as disclosed can be applied to a wireless communication apparatus, such as a cell phone or a personal data assistant, by occupying a very small space, to generate unlimited animations and provide dynamic language classes. Particularly, the wireless communication apparatus applying an embodiment of the invention enables users to take classes or lessons on line at any moment and location in a cheaper cost and more flexible manner.

While the present invention has been particularly shown and described with reference to preferred embodiments thereof, it will be understood by those of ordinary skills in the art, that the various changes in form and details may be made therein without departing from the spirit and scope of the present invention as defined by the appended claims.

What is claimed is:

1. An executing method for playing multimedia in a wireless communication apparatus, comprising steps of:
obtaining an animation data having a plurality of animation messages;
retrieving a plurality of information data according to one of the animation messages;
executing the information data; and
repeating the steps of retrieving a plurality of information data according to one of the animation messages and executing the information data until all the animation messages have been retrieved.

2. The executing method of claim 1, further comprising a step of analyzing the animation messages after the step of obtaining an animation data having a plurality of animation messages.

3. The executing method of claim 2, wherein the step of analyzing the animation messages includes analyzing at least one information data index message, at least one information data address message and one timing message.

4. The executing method of claim 3, wherein the step of analyzing the information data index message includes analyzing a picture index message and a text index message, and the step of analyzing the information data address message includes analyzing a picture address message.

5. The executing method of claim 4, wherein the step of analyzing the picture index message includes analyzing at least one picture index and the step of analyzing the picture address message includes analyzing at least one picture address, wherein the picture address corresponds to a respective one of the picture index.

6. The executing method of claim 3, wherein one of the information data index messages correspond to one of the information data address messages.

7. The executing method of claim 1, further comprising using an application program to perform each the steps.

8. The executing method of claim 7, wherein the application program is a Java application program.

9. The executing method of claim 1, wherein the step of obtaining an animation data having a plurality of animation messages includes obtaining a total number of the animation messages and the animation messages

10. The executing method of claim 1, wherein the step of retrieving a plurality of information data according to one of the animation messages includes retrieving at least one picture and at least one text.

11. The executing method of claim 10, wherein the step of retrieving a plurality of information data according to one of the animation messages further comprises retrieving at least one sound.

12. An executing module for playing multimedia in a wireless communication apparatus, comprising:
a storage module for storing at least one animation data and a plurality of information data, wherein each the animation data includes a plurality of animation messages;
a retrieving module connected with the storage module for retrieving one of the animation messages;
a comparison module connected with the retrieving module for analyzing the animation message in the retrieved animation message and obtaining the information data according to the analyzed animation message; and
an executing module connected with the comparison module for executing the information data, thereby generating an animation.

13. The executing module of claim 12, wherein the storage module stores the animation data and the information data, which are downloaded from a network.

14. The executing module of claim 12, wherein each the information data is one of one picture, one text and one sound.
